(19) United States
(12) Patent Application Publication
(10) Pub. No.: US 2007/0284898 A1
(43) Pub. Date: Dec. 13, 2007

(54) Animal waste receptacle

(76) Inventors: Richard S. Miroe, Great Neck, NY (US); Ted Miroe, Great Neck, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/801,854

(22) Filed: May 11, 2007

Related U.S. Application Data
(60) Provisional application No. 60/799,691, filed on May 11, 2006.

(51) Int. Cl. A01K 29/00

(52) U.S. Cl. 294/1.5

(57) ABSTRACT

An animal waste receptacle is disclosed. The animal waste receptacle includes a harness, a handle, a holding structure and a release mechanism. The harness is configured to be removably secured to an animal. The handle is removably secured to the harness with an attachment device and the handle is configured to extend from the harness towards an animal's rear. The holding structure is disposed in mechanical cooperation with the handle and is configured to releasably hold a bag adjacent the animal's rear. The release mechanism is disposed in mechanical cooperation with the handle. Activation of the release mechanism causes a bag to be released from the holding structure.

### CROSS-REFERENCE TO RELATED APPLICATION

This application claims the benefits of and priority to U.S. Provisional Patent Application Ser. No. 60/799,691 entitled “PET WASTE RECEPTACLE” which was filed on May 11, 2006, the entire contents of which are hereby incorporated by reference herein.

### BACKGROUND

1. Field of the Disclosure

The present disclosure relates to sanitary devices for animals and more particularly to a waste collecting receptacle for animals, especially dogs, intended to collect feces from the animal and allow disposal thereof in a sanitary manner.

2. Background of the Art

A variety of products have been developed that are designed to provide pet owners with effective and sanitary means of disposing of their pet's waste. These products include a number of pet septic disposal systems that act as repositories for waste material and provide for the addition of chemical agents, largely enzymes, to advance the decomposition of the waste. Another product involves a small shovel or scooper for picking up the waste and transferring it into a small container or disposable bag. Both of these products can be troublesome and unpleasant to use, particularly the scooper which is required to be carried by the pet owner and used carefully in order to remove all of the waste from the ground. Since it is designed for reuse, the scooper is also usually cleaned following each use. Thus, pet owners often avoid using the scooper to avoid the task of cleaning it.

Another type of device for dealing with this problem of animal waste is one worn by the animal and designed to catch the animal waste upon discharge. Such devices may include a harness that is strapped around the body of the animal and a bag designed for attachment to the harness in a position proximate to the anal region of the animal. These devices can effectively prevent animal waste from contacting the ground and soiling interior surfaces and in so doing, can eliminate offensive sights and odors. The use of such harness-type devices, however, has been somewhat limited by costs, complications of production and by the lack of comfort generally afforded the animal.

### SUMMARY

The present disclosure relates to an animal waste receptacle. The animal waste receptacle includes a harness, a handle, a holding structure and a release mechanism. The harness is configured to be removably secured to an animal. The handle is removably secured to the harness with an attachment device and the handle is configured to extend from the harness towards an animal's rear. The holding structure is disposed in mechanical cooperation with the handle and is configured to releasably hold a bag adjacent the animal's rear. The release mechanism is disposed in mechanical cooperation with the handle. Activation of the release mechanism causes a bag to be released from the holding structure.

The present disclosure also relates to a system for receiving animal waste. The system includes an animal waste receptacle and a bag for use therewith. The animal waste receptacle includes a harness, a handle, a holding structure and a release mechanism. The harness is configured for removable securement to an animal. The handle is removably secured to the harness. The holding structure is disposed in mechanical cooperation with the handle and is configured to releasably hold the bag adjacent an animal's rear. The release mechanism is disposed in mechanical cooperation with the handle. The bag is configured to be releasably held by the holding structure. Activation of the release mechanism causes the bag to be released from the holding structure.

The present disclosure also relates to a method of deposing animal waste. The method includes providing an animal waste receptacle, providing a bag for use with the animal waste receptacle, allowing the animal to excrete waste into the bag, removing the handle from the harness and activating the release mechanism to cause the bag to be released from the holding structure. The animal waste receptacle includes a harness configured for removable securement to an animal, a handle removably secured to the harness, a holding structure disposed in mechanical cooperation with the handle and configured to releasably hold a bag adjacent an animal's rear, and a release mechanism disposed in mechanical cooperation with the handle.

### BRIEF DESCRIPTION OF THE DRAWINGS

Embodiments of the present disclosure are described hereinbelow with reference to the drawings wherein:

FIG. 1 is a perspective view of an animal waste receptacle of the present disclosure shown with a bag and being worn by a dog;

FIG. 2 is a perspective view of the animal waste receptacle of FIG. 1, illustrating a handle detached from a harness;

FIG. 3 is a perspective view of the animal waste receptacle of FIGS. 1 and 2, illustrated with a bag held thereon;

FIG. 4A is a perspective view of the bag of FIGS. 1 and 3;

FIG. 4B is a side view of the bag of FIGS. 1, 3 and 4a and a holding structure in an open position;

FIG. 4C is a side view of the bag and holding structure of FIG. 4B in a partially closed position; and

FIG. 4D is a side view of the bag and holding structure of FIGS. 4B and 4C in a closed position.

### DETAILED DESCRIPTION

Embodiments of the presently disclosed animal waste receptacle are described in detail with reference to the drawings, in which like reference numerals designate identical or corresponding elements in each of the several views.

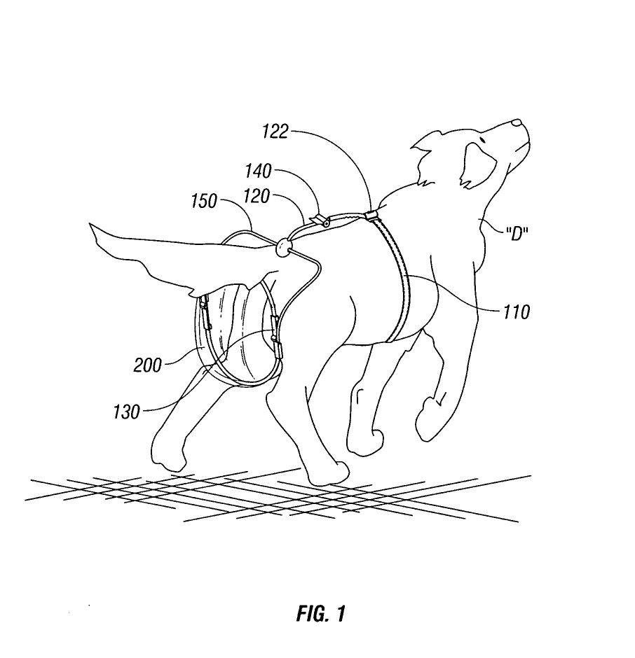

An animal waste receptacle in accordance with the present disclosure is referred to in the figures as reference number 100. Referring initially to FIG. 1, animal waste receptacle 100 is shown being worn by a dog “D” and having a bag 200 removably secured thereto. Animal waste receptacle 100 is configured to position bag 200 adjacent the rear of the dog D, such that waste excreted by the dog D is caught in bag 200.

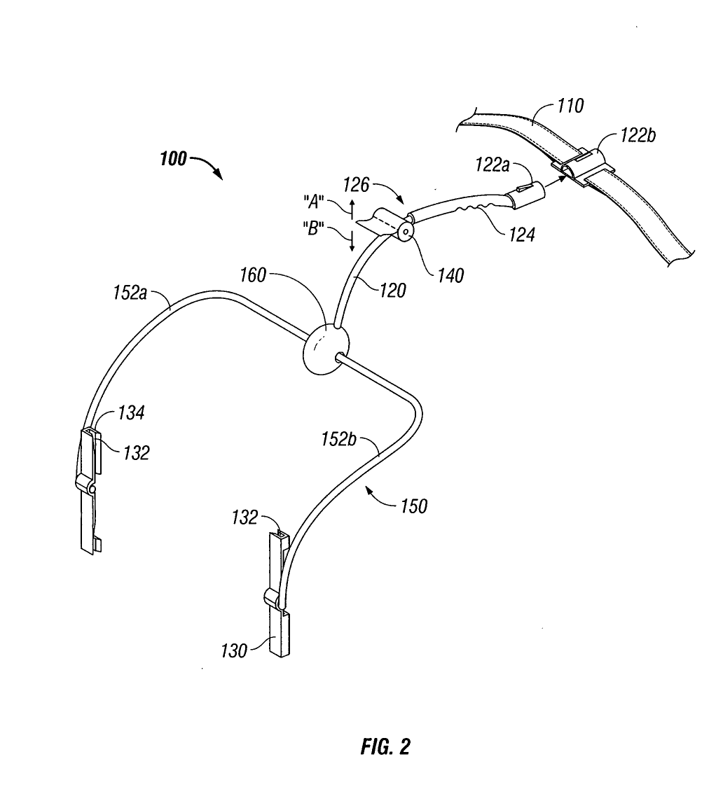

According to the present disclosure and with specific reference to FIGS. 1 and 2, animal waste receptacle 100 includes a harness 110, a handle 120, a holding structure 130 and a release mechanism 140. Harness 110 is configured to be removably secured to an animal, e.g., around the animal's torso, as shown in FIG. 1. It is envisioned that harness 110 is secured on an animal in any suitable way, including with the use of a tightenable strap, hook and loop fasteners, snaps, buttons, etc.

Handle 120 of animal waste receptacle 100 is removably secured to harness 110 via an attachment device 122. It is envisioned that attachment device 122 includes a first portion 122a disposed on handle 120 and a second portion 122b disposed on harness 110. In the illustrated embodiments, attachment device 120 includes an umbrella-type spring. It is envisioned however, that other types of attachment devices 122 may be used to removably secure handle 120 with harness 110.

Referring to FIGS. 1-3, holding structure 130 of animal waste receptacle 100 is disposed in mechanical cooperation with handle 120 and is configured to releasably hold bag 200. Further, holding structure 130 is positioned and configured such that holding structure 130 holds bag 200 adjacent the animal's rear or anus.

Release mechanism 140, illustrated in FIGS. 1-3, is disposed in mechanical cooperation with handle 120. Activation of release mechanism 140 (e.g., depressing a button, pulling a trigger, flipping a switch, turning a knob, pulling a lever, pushing a lever, etc.) causes bag 200 to be released from holding structure 130. It is also envisioned that activation of release mechanism 140 causes bag 200 to be closed. Specifically, in a disclosed embodiment, it is envisioned that pulling a lever of release mechanism 140 (in the direction of arrow “A” in FIG. 2) causes bag 200 to close and pushing the same lever of release mechanism 140 (in the direction of arrow “B” in FIG. 2) causes bag 200 to be released from holding structure 130.

In use, it is envisioned that animal waste receptacle 100 with bag 200 releasably attached thereto is worn by a dog. After a dog excretes waste into bag 200, a user (e.g., the dog's owner and/or walker) may activate release mechanism 130 to close bag 200, remove handle 120 from harness 110, carry handle 120 with holding structure 130 and bag 200 (with excrement therein) to a waste basket (or similar disposal area), and activate release mechanism 140 to cause bag 200 to be released from holding structure 130 and into the garbage. The user may then insert another bag 200 onto holding structure 130 and reattach handle 120 to harness 110.

In the illustrated embodiments, animal waste receptacle 100 includes a fork structure 150 disposed between handle 120 and holding structure 130. Fork structure 150 includes a pair of prongs 152a, 152b, with each prong 152a, 152b including a portion of holding structure 130 thereon. Prongs 152a, 152b of fork structure 150 are configured to extend from handle 120 on either side of an animal's tail (FIG. 1), such that each portion of holding structure 130 is positioned on either side of the animal's anus.

A hub 160 is illustrated disposed between handle 120 and fork structure 150. It is envisioned that hub 160 is part of handle 120 and that hub 160 contacts the animal when animal waste receptacle 100 is worn by the animal. It is further envisioned that hub 160 includes a padded and/or soft surface thereon, e.g., neoprene, to enhance the animal's comfort level. Further, fork structure 150 may extend in an angled and/or curved-like fashion from hub 160 such that a majority of the surface of fork structure 150 does not contact the animal, thus further enhancing the comfort level of the animal.

In accordance with the illustrated embodiments of the present disclosure, handle 120 is curved along a majority of its length. That is, the illustrated embodiments depict that handle 120 only contacts the dog adjacent harness 110 and adjacent hub 160. This limited amount of contact between handle 120 and dog augments the comfortability factor for the dog. Additionally, curved handle 120 facilitates the engagement and disengagement between handle 120 and harness 110. That is, a user may remove handle 120 from harness 110 (and attach handle 120 to harness 110) without substantially contacting the dog, as the curvature of handle 120 allows a user's hand to be placed between the dog and handle 120.

It is also envisioned that handle 120 includes a gripping portion 124 (FIG. 2) disposed thereon (e.g., adjacent attachment device 122) to enhance the grip of a user. Additionally, handle 120 may be configured such that release mechanism 140 and attachment mechanism 122 can be activated by a single hand of a user without the need for the user to substantially reposition his or her hand. That is, a user may use one hand to remove handle 120 from harness 110 and to activate release mechanism 140, while the other hand is free (e.g., to hold the dog's leash). Further, the user may reattach handle 120 with harness 110 without the need of his other hand.

It is further disclosed that handle 120 may be extendable via a telescoping portion 126 (FIG. 2). In this embodiment, telescoping portion 126 helps allow handle 120 to have a plurality of different lengths. As such, length of handle 120 can be adjusted to allow animal waste receptacle 100 to more easily properly fit on a variety of different sized animals. It is envisioned that telescoping portion 126 includes a first shaft having a cross-section of a first size and a second shaft having a similar cross-section of a smaller size, such that at least a portion of second shaft can fit within at least a portion of first shaft. It is further envisioned that handle 120 may include a locking mechanism to temporarily secure each shaft in place with respect to one another.

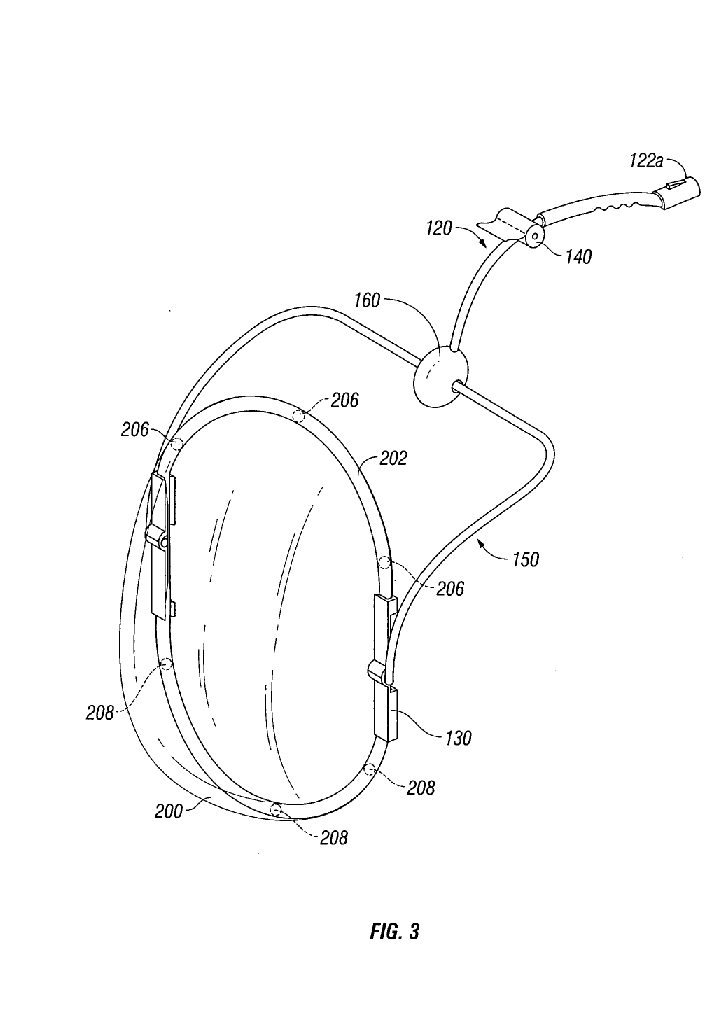

With reference to FIGS. 2 and 3, holding structure 130 is shown including a plurality of channels 132. Each channel 132 is configured and dimensioned to releasably hold a portion of bag 200 therein. It is envisioned that at least a portion of at least one channel 132 includes a bevel-type edge 134. Bevel-type edge 134 may facilitate positioning and/or retaining bag 200 within holding structure 130. FIG. 3 illustrates a portion of bag 200 being held within holding structure 130.

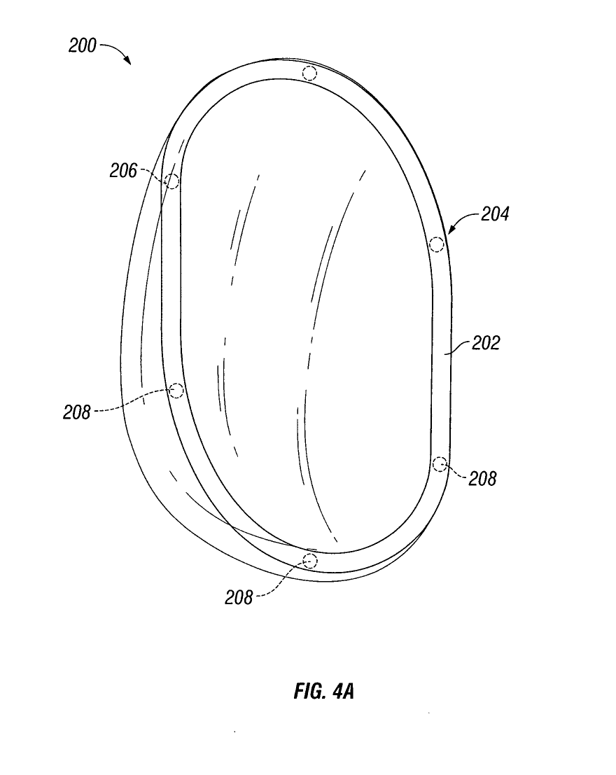

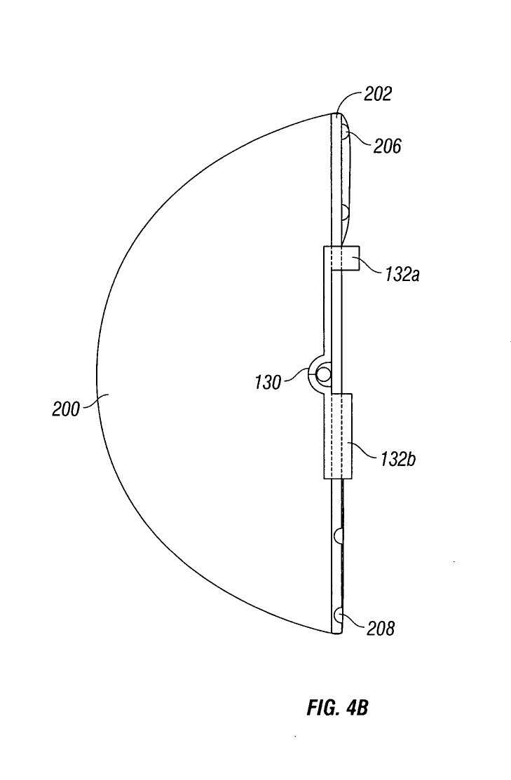

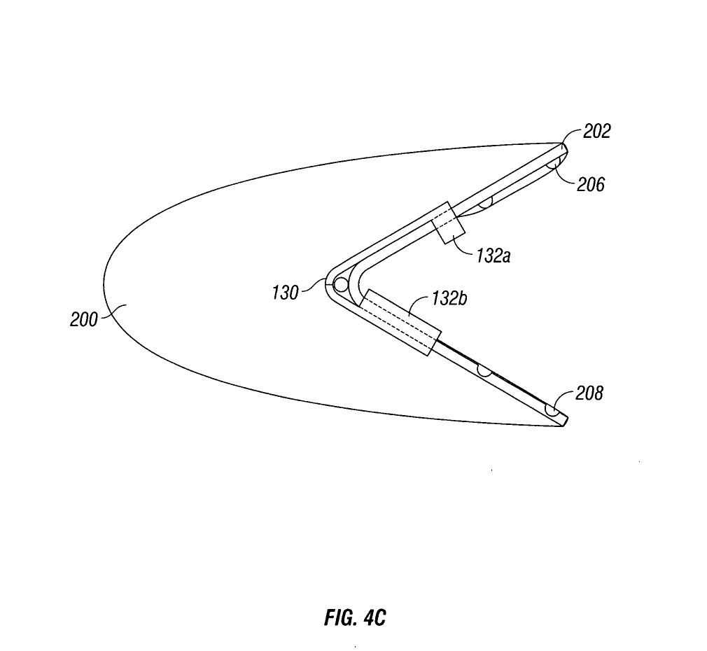

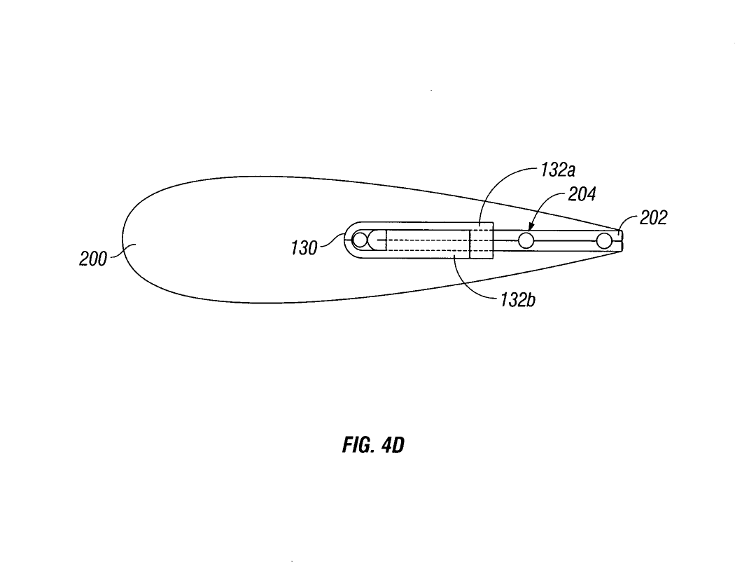

It is further envisioned that channels 132 of holding structure 130 are configured to interlock with one another upon being folded (see FIGS. 4B-4D). That is, channels 132 disposed on the same prong (e.g., 152a) of fork structure 150 are configured and situated such that when the corresponding portion of holding structure 130 is approximated, a first portion of channel 132a will not contact an opposite second portion of channel 132b. For example, it is envisioned that a portion of first portion of channel 132a is shorter and wider than second portion of channel 132b. Further, it is envisioned that first portion of channel 132a and second portion of channel 132b are configured such that one portion of channel 132 (e.g., first portion 132a) can fit (e.g., via a snap-like connection) at least partially within the other portion of channel 132 (e.g., second portion 132b).

As indicated above, actuation of release mechanism 140 causes bag 200 to be released from holding structure 130 and/or causes closure of bag 200. Specifically, it is envisioned that a mechanical (e.g., wire), electrical and/or electromechanical structure may be used to facilitate the release and/or closure of bag 200. FIGS. 4B-4D illustrate closure of bag 200 in different stages. As discussed above, it is envisioned that channels 132 are configured such that bag 200 can be fully closed and/or sealed. A top portion 202 of bag 200 may be substantially rigid to facilitate positioning of bag 200 with respect to channels 132. Further, top portion 202 of bag 200 may include structure 204 thereon to help place and/or maintain bag 200 in a closed position. As shown, structure 204 may include a plurality of protrusions 206 and corresponding apertures 208 to facilitate maintaining bag 200 in a closed and/or sealed position. Accordingly, a user may close bag 200 (e.g., completely close bag 200) prior to releasing bag 200 from handle 120, thus maintaining the waste (and any associated odors) within bag 200 in a sanitary manner.

Additionally, bag 200 may be configured to close automatically. For instance, bag 200 may close upon waste being excreted therein (e.g., the weight of the waste causes bag 200 to close), or bag 200 may close upon being moved away from the animal. Here, holding structure 130 may be biased (e.g., mechanically biased) towards a closed position, where a first portion 136 of holding structure 130 is approximated with a second portion 138 of holding structure 130. Moreover, a hinge 139 (e.g., a living hinge) may be disposed between first portion 136 and second portion 138 to facilitate the movement of holding structure 130.

A system for receiving animal waste is also contemplated by the present disclosure. The system includes animal waste receptacle 100, such as that described above, and bag 200. It is envisioned that the system includes a plurality of disposable bags 200. Additionally, bag 200 may be configured differently than explicitly illustrated in the accompanying figures. For example, bag 200 may be substantially flat (i.e., in a single plane) when being worn by a dog and when empty. Here, the excretion of waste would cause at least a portion of bag 200 to move out of the plane. Further, a portion of bag 200 (e.g., top portion 202) may be rectangular or any other regular or irregular shape.

A method of disposing animal waste is also contemplated by the present disclosure. The method includes providing animal waste receptacle 100, such as that described above, providing bag 200 for use with animal waste receptacle 100, allowing the animal to excrete waste into bag 200, removing handle 120 from harness 110, and activating release mechanism 140 to cause bag 200 to be released from holding structure 130.

While the above description contains many specifics, these specifics should not be construed as limitations on the scope of the present disclosure, but merely as illustrations of various embodiments thereof. For example, while the only animal explicitly discussed herein is a dog, the word animal is not intended to be limited to dogs as other animals are included by the present disclosure. It is also envisioned that a tether or leash is disposed between (and/or connected to) harness 110 and handle 120, such that the animal is not free to run from the user upon removal of handle 120 from harness 110. Therefore, the above description should not be construed as limiting, but merely as exemplifications of various embodiments. Those skilled in the art will envision other modifications within the scope and spirit of the claims appended hereto.

What is claimed:

1. An animal waste receptacle, comprising:
a harness configured for removable securement to an animal;
a handle removably secured to the harness via an attachment device, the handle configured to extend from the harness towards an animal's rear;
a holding structure disposed in mechanical cooperation with the handle and configured to releasably hold a bag adjacent the animal's rear; and
a release mechanism disposed in mechanical cooperation with the handle, wherein activation of the release mechanism causes a bag to be released from the holding structure.

2. The animal waste receptacle of claim 1, further including a fork structure disposed between the handle and the holding structure.

3. The animal waste receptacle of claim 2, wherein the fork structure includes two prongs and wherein a portion of the holding structure is disposed on each prong.

4. The animal waste receptacle of claim 1, wherein the handle includes a length and is curved along a majority of its length.

5. The animal waste receptacle of claim 1, wherein the handle includes a length and wherein the handle is configured such that, when in place on an animal, a majority of the length of the handle does not contact the animal.

6. The animal waste receptacle of claim 1, wherein the handle includes a telescoping portion such that a length of the handle can be adjusted.

7. The animal waste receptacle of claim 1, wherein the holding structure includes a plurality of channels, and wherein each channel is configured to accept a portion of a bag at least partially therein.

8. The animal waste receptacle of claim 7, wherein at least a portion of a channel includes a bevel-type edge configured to facilitate insertion of a bag at least partially within the channel.

9. The animal waste receptacle of claim 1, wherein activation of the release mechanism causes a bag to at least partially close.

10. The animal waste receptacle of claim 1, wherein activation of the release mechanism causes a bag to completely close.

11. The animal waste receptacle of claim 1, wherein the handle is configured such that the release mechanism and the attachment mechanism can be activated by a single hand of a user without the need for substantial repositioning of the user's hand.

12. A system for receiving animal waste, comprising:
an animal waste receptacle, including:
a harness configured for removable securement to an animal;
a handle removably secured to the harness;
a holding structure disposed in mechanical cooperation with the handle and configured to releasably hold a bag adjacent an animal's rear; and
a release mechanism disposed in mechanical cooperation with the handle; and
a bag configured to be releasably held by the holding structure,
wherein activation of the release mechanism causes the bag to be released from the holding structure.

13. The system of claim 12, wherein the handle includes a length and is curved along a majority of its length.

14. The system of claim 12, wherein the holding structure includes a plurality of channels, and wherein each channel is configured to accept a portion of the bag at least partially therein.

15. The system of claim 12, wherein activation of the release mechanism causes the bag to at least partially close.

16. The system of claim 12, wherein a top portion of the bag includes structure to help maintain the bag in a closed position.

17. A method of disposing animal waste, comprising:
providing an animal waste receptacle, including:
a harness configured for removable securement to an animal;
a handle removably secured to the harness;
a holding structure disposed in mechanical cooperation with the handle and configured to releasably hold a bag adjacent an animal's rear; and
a release mechanism disposed in mechanical cooperation with the handle, wherein activation of the release mechanism causes a bag to be released from the holding structure;
providing a bag for use with the animal waste receptacle;
allowing the animal to excrete waste into the bag;
removing the handle from the harness; and
activating the release mechanism to cause the bag to be released from the holding structure.

18. The method of claim 17, wherein the handle includes a length and is curved along a majority of its length.

19. The method of claim 17, wherein the holding structure includes a plurality of channels, and wherein each channel is configured to accept a portion of the bag at least partially therein.

20. The method of claim 17, wherein activation of the release mechanism causes the bag to at least partially close.
